(19) United States
(12) Patent Application Publication
(10) Pub. No.: US 2003/0225649 A1
(43) Pub. Date: Dec. 4, 2003

(54) System and method for automatically investing in an investment or savings account by using the "rounded up" of credit card purchase amounts to produce savings/investment amounts

(76) Inventor: Mark S. Simpson, Hilton Heap Island, SC (US)

Correspondence Address: CLARENCE J. FLEMING, 2 MARSH VIEW DRIVE, HILTON HEAD ISLAND, SC, 29928, US

(21) Appl. No.: 10/442,931

(22) Filed: May 21, 2003

Related U.S. Application Data
(60) Provisional application No. 60/384,426, filed on May 31, 2002.

(51) Int. Cl. G06F 17/60

(52) U.S. Cl. 705/35

(57) ABSTRACT

A central computer includes data input means, data processing means and data storage means and is used by a credit card issuer for automatically funding an investment for the credit card holder. A rounded-up numerical figure selected by the cardholder is stored in the memory of the computer. The computer maintains a record of the purchase or advance amount each time the cardholder uses the creditcard. The data processing means determines, with reference to the rounded-up numerical figure, a rounded amount which is in excess of the purchase or advance amount. The data processing means also determines a savings amount (which is periodically transferred to the investment account) by subtracting the purchase or advance amount from the rounded amount.

### BACKGROUND OF INVENTION

This application is based on provisional application number 60/384,426, filed May 31, 2002.

Credit cards which offer rewards or rebates based upon usage of the credit facility are common. Credit card firms, such as VISA and MasterCard, automobile manufacturers, rental car companies, department stores, long distance telephone companies, financial institutions and other organizations have offered a number of different programs for promoting purchases of goods and services. Some offer free airline tickets while others offer credit toward the purchase of gasoline, automobiles or movie rentals.

The present invention allows credit card issuers, or entities associated therewith, to promote purchases of goods and services while at the same time encouraging credit card holders to save and invest for retirement or other purposes, such as saving for college tuition, by use of a special credit card.

In the current environment of (1) high credit card use, and (2) low savings and inadequate planning for retirement or the substantial expenses of college tuition, a system which provides incentives to credit card users to begin saving for retirement or college, or increase or accelerate retirement or college savings is an idea whose time has come. The use of the invention described herein will introduce the spending side of the population to the saving side.

The present invention is particularly timely during a period when social security payments from the Federal government are no longer assured and when many corporations are discontinuing or phasing out their long-standing pension programs. Similarly, the cost of a college education has never been higher and if current estimates are to be believed, will continue to rise dramatically.

The present invention offers individuals the opportunity to “spend their way to retirement” or to “spend their way to a quality college education” for their children.

The present invention employs “rounding up” of a credit card charged amount to achieve, in effect, automatic savings for transfer to an investment account.

As concerns the prior art, U.S. Pat. No. 6,119,099 discloses a system wherein a point-of-sale terminal, located at a check-out counter at a consumer goods store, such as a drug store or food market, for example, determines an upsell amount to offer in exchange for the change due a customer in connection with a purchase. The point-of-sale terminal is programmed to determine an upsell amount. If the customer accepts the upsell amount rather than the actual sale amount, the customer receives the upsell, such as a novelty item, in exchange due, thus obviating the sometimes time consuming procedure of returning to the customer the coins due as change. Here, the customer does not achieve savings but on the contrary is actually induced to pay more than the initial purchase price of the goods.

U.S. Pat. No. 6,070,153, issued to the present inventor, discloses a system and method for automatically funding an investment account by applying to that account a portion of the interest charged by a credit card issuing entity. The transfer is made periodically after payment by the creditcard holder.

### SUMMARY OF THE INVENTION

The present invention relates to a credit card product which is used to fund an automatic Individual Retirement Account, Taxpayer Relief Act of 1997 or “Roth Act” or “Super IRA,” Spousal IRA, College Education IRA or 529 plan, savings account such as a College Savings Account, 401(K) Profit Sharing Plan, SEP or Dividend Reinvestment Plan (in stock of the card issuer or otherwise) or other investment account (hereinafter, collectively the “Investment Account”).

The invention resides in an automatic savings method involving the “rounding up” of credit card charged amounts to the nearest selected higher increment, such as the nearest $5.00, $10.00 $50.00 or $100.00 amount. For example, assume the credit card holder uses the credit card to make a purchase in the amount of $22.35, hereinafter the “charged amount.” Also assume that the card holder selected the next highest $10.00 as the rounded up figure. Thus, the card holder would be charged $30.00, hereinafter the “rounded amount.” The difference between the charged amount and the rounded amount, here $7.65, is the “savings amount.” The savings amount would eventually (depending on the payment practices of the card holder) be transferred by the credit card issuer, or related entity, to an Investment Account for the card holder.

As indicated above, the Investment Account may be a savings account, a retirement account or college savings account, such as a Regular or Roth IRA, Education IRA, college savings account or 529 plan, or a Dividend Reinvestment Plan (DRIP) of a corporate card issuer, such as General Motors.

At the end of the month, or at the end of such other billing period, the credit card issuer, or related entity, would issue a statement to the credit card holder. The statement would show the totals of the charged amounts, the rounded amounts and the savings amounts, along with any past due amounts and interest charges. Upon payment of the total amount in full by the card holder, the savings amount would be transferred to the card holder's Investment Account by the credit card issuer, or related entity. If the card holder paid only a portion of the amount due, or minimum payment amount, the payment would be applied in the manner envisioned by the card issuer when the minimum payment amount is calculated. Any excess amount would first be applied to interest and then to principal. Let us consider the following payment examples.

Assume the credit card holder receives a statement in a total amount of $500.00 with no past due amount or interest charges. Also assume the statement shows $450.00 in charged amounts and $50.00 as the total savings amount. If the total amount is paid in full in a timely manner (so as to avoid interest charges), the credit card issuer, or other entity receiving payment, would transfer the $50.00 savings amount to the credit card holder's Investment Account upon receiving such payment

Now let us assume in this example that the credit card holder makes a partial or minimum required payment in the amount of $102.50. If the minimum payment is calculated as interest owed plus 10% of the principal balance plus savings amount and the interest rate is 20%, then the payment of $102.50 would be allocated as follows: $7.50 to interest, $45 to principal; and $50 to the Investment Savings Account.

In a still further example assume the credit card holder receives a statement showing $450.00 as the total charged amount. $50.00 as the savings amount and $7.50 as interest charges, for a total of $507.50. If the card issuer required payment of all interest charges and charged amounts prior to the transfer of investment/savings amounts, then $7.50 interest plus the $450.00 charged, or $457.50 would need to be paid by the card holder prior to any amount transferred to the Investment Savings Account. A partial payment would first be applied to cover the $7.50 interest charge. Any remainder of the payment would be applied to the $450.00 charged amount. Only upon payment of all interest, charged amounts and savings/investment amount in full would the $50.00 savings amount be transferred to the Investment Account of the credit card holder. Needless to say, this procedure would be an inducement to the card holder to make timely and full payments, not only to avoid interest payments, but also to realize funding of the Investment Account.

In the second example above, unpaid investment/savings amounts, if any, would be billed to the card holder the next billing period without interest, or such amounts, if not paid within a prescribed time period by the card holder, could be deleted.

The method described above could quite logically be added to other funding methods, thus providing multiple ways to save for retirement, would provide a method to shift the burden of funding the Investment Account to the cardholder/investor and would increase the performance of the system of the present invention. In particular, this method could be combined with the method disclosed and claimed in U.S. Pat. No. 6,070,153, referred to above. This patented method includes rebating to an Investment Account a portion of the interest charged to and paid by the card holder.

The credit card issuer could retain the right to invade the Investment Account in the event of default in payment by the borrower. It is also possible that the credit card issuer, or related entity, could retain the invasion right for the life of the credit card account. The Investment Account could be restricted such that it could not be transferred until the credit card holder satisfied all of his or her obligations to the credit card issuer. These methods would serve to reduce card issuer losses and thus costs.

The cardholder/investor could also make optional additional investments to the Investment Account—which would not be subject to any offset for bad credit—up to the government established IRA, Education IRA, college 529 plan or 401(K) Plan investment ceilings. The IRA, Education IRA, 529 Plan and 401(K) Plan accounts would be the same—following the satisfaction of card holder obligations to the card issuer—as existing IRA and 401(K) Plan investment accounts.

The method of the invention could very easily be adapted to a corporate format for expense account credit cards with corresponding individual 401(K), IRA's, Education IRA, 529 Plan or SEP accounts established.

A brief summary follows showing how a credit card issuing company would set up and operate the present invention employing a suitable computer with memory, storage and data processing and display means.

a) The credit card issuing entity would solicit applications through a marketing program for a credit card account and an Investment Account.

b) Applicants would complete application documentation for both accounts and return them to the credit card issuing entity.

c) Separate account records would be set up for the credit card accounts and corresponding Investment Accounts. These data bases would be linked by account numbers and cross-referenced in that fashion.

d) Account management systems would be developed and put into place to handle the payment status of the credit card facilities and the transfer of funds directly to the Investment Accounts depending on the payment practices of the credit card holder.

If the credit card is issued by a company that also provides investment account services, the issuer could charge a somewhat higher fee for account management services than in conventional investment accounts, to offset the possible lower balances (at least initially) of these accounts.

Another benefit of issuance of the credit facility by a mutual fund or investment company would be the joint marketing benefits—the credit facility could be used as an added benefit for investors—and the savings component would be attractive to all credit card users. Also, profiting from both aspects of the transaction would allow the mutual fund or investment company card issuer to adjust all of the aspects of the transactions to find the most profitable mix.

### DESCRIPTION OF THE DRAWINGS

FIG. 1 is an operational flow chart of the credit application phase of the system and method of the invention;

FIG. 2 is an operational flow chart of the credit card use phase of the system and method of the invention;

FIG. 3 is an operational flow chart of the Investment Account funding phase of the system and method of the invention; and

FIG. 4 is a schematic of a computerized system for performing the present invention.

### DESCRIPTION OF A PREFERRED EMBODIMENT

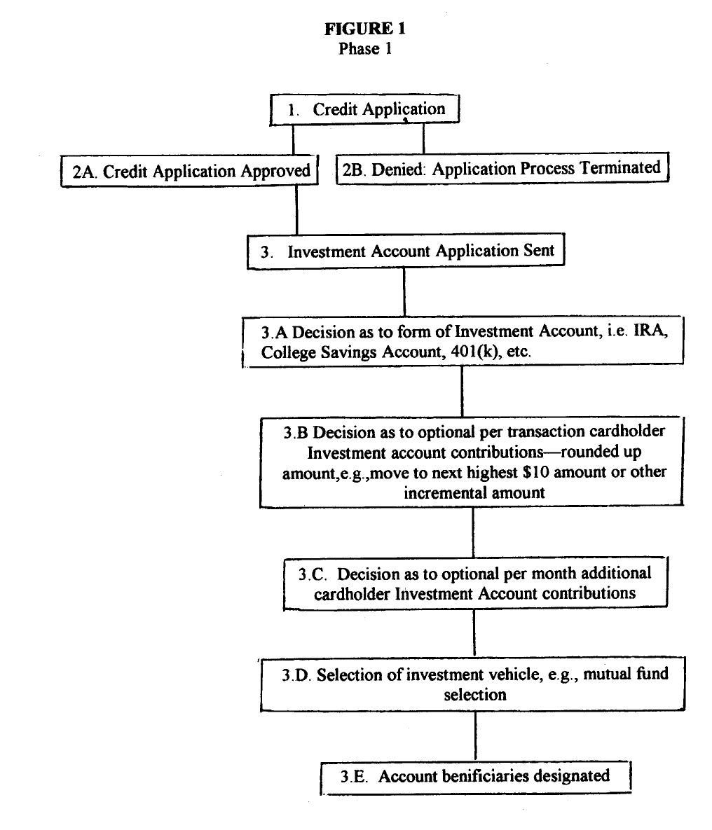

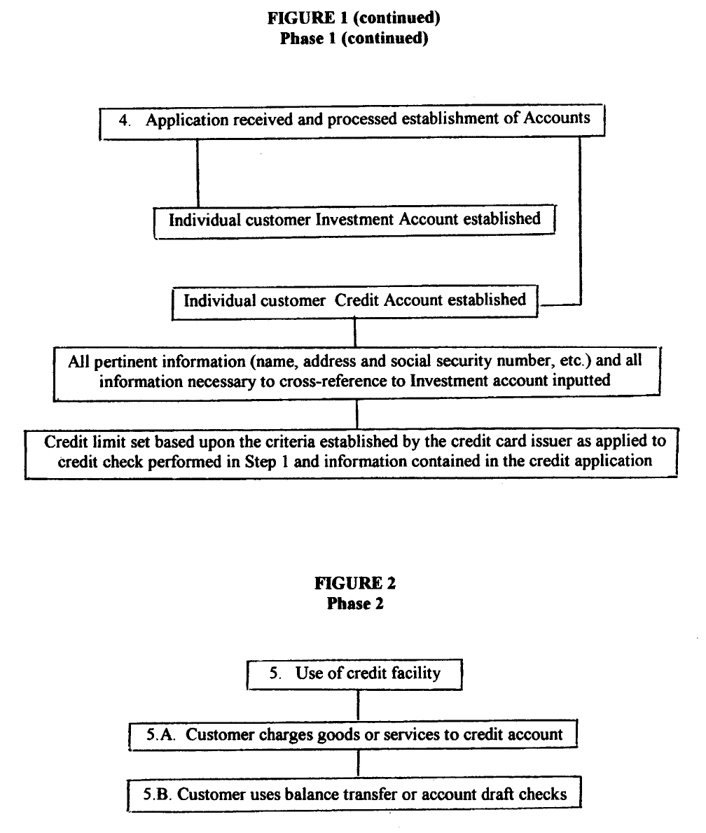

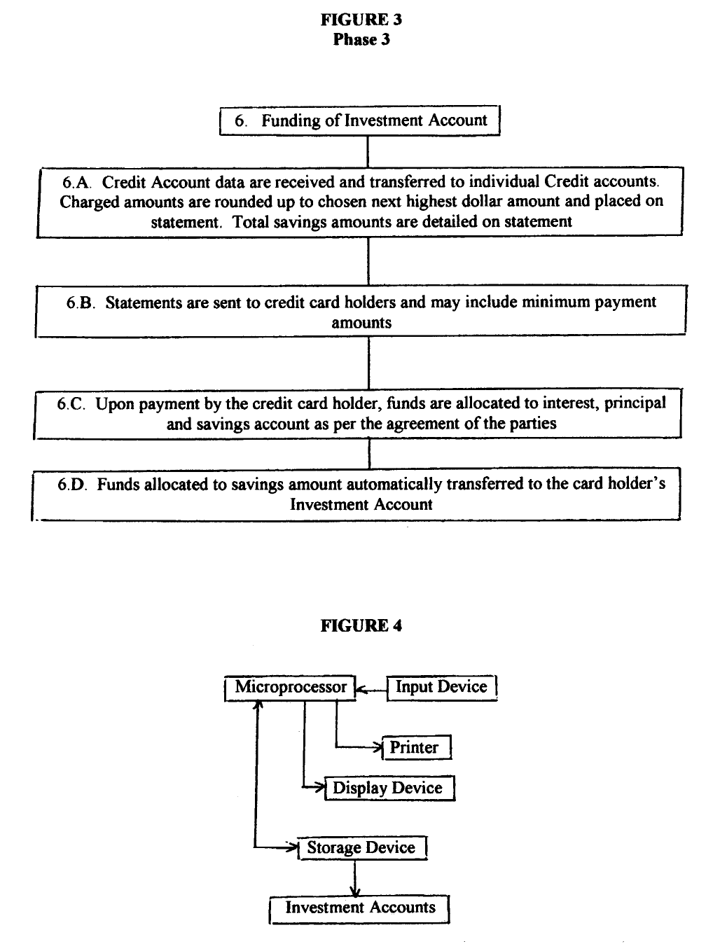

Referring to FIGS. 1-3, the operation of the system and method of the invention is as follows:

Step 1—Credit Facility Application.

A customer, i.e., the potential credit card holder, applies for a credit card account by filling out and returning a credit application. The credit application will contain all customary required disclosures such as finance charges, minimum payment requirements, Investment amount, transfer procedures, fees, etc.

Step 2—Approval or Denial of Credit Application.

2A. If approved, the customer is sent additional information about the credit facility including credit limit, a credit card or cards, investment account application materials and more information about the Investment Account.

2B. If denied, the credit application process is terminated, but the customer is still sent information about IRA, college savings plans or other investment accounts and offered the opportunity to invest if desired.

Step 3—Investment Account Application.

Simultaneously with the credit facility application, upon credit approval and acceptance by the issuer, the cardholder/investor fills out an IRA Application and Custodial Agreement (or similar documentation for other types of Investment Accounts) which contain the agreement on behalf of the customer regarding the custodial relationship, and to any “set-off” or account “invasion” rights of the issuer for bad debts.

3A. The application would require the cardholder/investor to state whether the IRA is to be a Regular, Roth, Spousal or Educational IRA, or what other form the Investment Account is to take, i.e. 401(k), 529 Plan, for example.

3B. The cardholder/investor designates the “roundedup” amounts in increments, such as $5.00, $10.00, $25.00, $50.00 $100.00 per transaction using the credit cardholder's credit card.

3C. The Application would also offer the cardholder/investor the opportunity to establish automatic savings options and to receive applications for additional accounts upon request.

3D. The Investment Account application would also require the cardholder/investor to select an investment fund (this assumes that the issuer would offer fund alternatives, i.e. Blue Chip Stock Fund, Corporate or Municipal Bond Fund, etc.) and to agree to any applicable vesting schedule and optional additional monthly investments.

3E. The cardholder/investor will designate primary and residual beneficiaries.

Step 4.

The Investment Account application is reviewed by the issuer and processed. An individual cardholder credit account is established. All pertinent information (name, address and social security number, etc.) and all information necessary to cross reference to the Investment Account is inputted. A credit limit is set based upon the criteria established by the card issuer as applied to the credit check performed in Step 1 and information contained in the credit application. The individual cardholder/investors Investment Account with all offered and selected funding mechanisms in place is then established.

Step 5—Use of Credit Facility.

5A. Upon receipt of the credit card the cardholder can immediately charge goods and services to the credit account.

5B. Courtesy balance transfers or account draft checks (with or without a service charge) would also be provided for account access.

Step 6—Funding of Investment Account.

6A. Credit card holder use data is received by the credit card issuing entity and transferred to individual credit card holder credit accounts.

6B. Statements are sent by the credit card issuing entity to the credit card holder and may include minimum payment amounts.

6C. Upon payment by the credit card holder, funds are allocated to interest, principal and savings amounts in accordance with the agreement of the parties.

6D. Funds allocated to the savings amount are then transferred to the card holder's investment account.

FIG. 4 is a schematic of a computerized system for performing the method of the present invention, such system including a data storage means or memory, data processing means and data input means. The microprocessor and its associated components, viz. an input device, a printer and a display device, may be of conventional construction. The storage device is also conventional and may include a RAM, floppy disc, hard disc or a combination thereof.

While the present invention has been described herein by reference to the preferred embodiment, it will be understood by those skilled in the art that various changes may be made and added to the disclosed process and system without departing from the spirit or scope of the following claims:

What is claimed is:

1. A method to be employed by an offering entity, such as credit card issuer, for using a computer having a memory and associated data input means and data processing means to create and operate credit and investment accounts for individual cardholder/investors and to provide automatic investment into the investment account comprising:
(a) selecting a rounded-up numerical figure and storing the same in the memory of the computer;
(b) each time the cardholder/investor makes a purchase or processes an advance using a credit card of the offering entity, determining and storing a record of the purchase or advance amount in the computer memory;
(c) using the data processing means of the computer to determine, with reference to the rounded-up numerical figure, a rounded amount which is in excess of the purchase or advance amount;
(d) using the data processing means of the computer to determine a savings amount by subtracting the purchase or advance amount from the rounded amount; and
(e) using the data processing means of the computer to transfer the savings amount to the investment account.

2. The method according to claim 1 wherein the investment account is an individual retirement account.

3. A system for use by an offering entity, such as a credit card issuer, to provide for automatic investment in an investment account comprising:
(a) central computer means with associated data storage means, data processing means and data input means;
(b) the data input means including means for selecting and storing in the data storage means a rounded-up numerical figure;
(c) the data input means and the data processing means including means for determining and storing in the data storage means a record of the purchase or advance amount each time the cardholder/investor makes a purchase or processes an advance using the credit card of the offering entity;
(d) the data processing means including means to determine, with reference to the rounded-up numerical figure, a rounded amount which is in excess of the purchase or advance amount;
(e) the data processing means including means to determine a savings amount by subtracting the purchase or advance amount from the rounded amount; and
(f) the data processing means including means to transfer the savings amount to the investment account.

4. The system according to claim 3 wherein the investment account is an individual retirement account.

5. The method according to claim 1 wherein the investment account is an 401(k) plan.

6. The method according to claim 1 wherein the investment account is a 529 plan.

7. The method according to claim 1 wherein the investment account is a savings account.

8. The system according to claim 3 wherein the investment account is a 401(k) plan.

9. The system according to claim 3 wherein the investment account is a 529 plan.

10. The system according to claim 3 wherein the investment account is a savings account.
